(19) United States
(12) Patent Application Publication
(10) Pub. No.: US 2004/0128150 A1
(43) Pub. Date: Jul. 1, 2004

(54) Methods and structure for collaborative customer account management

(76) Inventor: Mark Edward Lundegren, Merriam, KS (US)

Correspondence Address: LATHROP & GAGE LC, 4845 PEARL EAST CIRCLE, SUITE 300, BOULDER, CO, 80301, US

(21) Appl. No.: 10/334,285

(22) Filed: Dec. 31, 2002

(51) Int. Cl. G06F 17/60

(52) U.S. Cl. 705/1

(57) ABSTRACT

Methods and associated structure for utilizing a planning template to enable collaborative management of strategic customer information within a business enterprise and for facilitating customer management or account management. Strategic customer information may be shared in a central repository by multiple users/entities within the business enterprise and by customers outside the enterprise. Data is entered using the planning template according to standardized requirements and formats to create a canonical form of the strategic customer information. Each user of the strategic customer information may view and/or modify the shared information through the planning template using a customizable “dashboard” interface. The dashboard interface may group the strategic customer information into one or more zones of related information defined by the planning template. The zones are provided according to the planning template to help enforce high quality in the gathering, management and application of the strategic customer information.

### BACKGROUND OF THE INVENTION

1. Field of the Invention

The invention relates to management of customer account information in a business and more specifically relates to automated methods and structures for collaborative management of strategic customer account information and for facilitating customer management or account management through use of a planning template.

2. Discussion of Related Art

Most business enterprises desire a high quality relationship with their respective customers and therefore such enterprises gather, manage and utilize a variety of information regarding customers. Quality of the customer relationship is widely accepted as an important measure of the probability of long-term success of a business enterprise. Though all customers are important to a business, certain customers may be deemed “strategic customers” in view of their relative importance to long-term strategies of the business. A strategic customer may be defined differently for different business enterprises but often reflects a higher volume of business than other customers of the enterprise. For example, a provider of financial services may provide services to small, individual customers through a directed marketing channel such as a retail outlet. Such customers may be important to the overall success of the business enterprise but no single one of these customers involves sufficient volume of business to represent a critical factor in the future success of the business. The same financial services business may also provide financial service products to a number of large volume customers. By contrast to the larger number of smaller customers, each of these larger customers (i.e., strategic customers) may be critical to the future success of the business enterprise. Loss of such a strategic customer or even a reduction of the volume of sales to such a strategic customer may significantly impact the future success of the business enterprise.

In view of the strategic significance of strategic customers, numerous entities within the business enterprise may be involved in gathering, managing and analyzing data regarding each strategic customer. Often there is a key account manager individual within the business enterprise that retains ultimate responsibility for success of the business relationship with the strategic customer (also referred to herein as the customer owner). This customer owner may gather data regarding plans for assuring customer satisfaction and for further development of business with the strategic customer. This customer owner, as the primary interface between the customer and the business entity, is most closely in touch with the needs of that particular customer. Executives within the business enterprise may gather and analyze information regarding performance of account managers relative to established standards and goals. Still further, business analysts and planners in the business enterprise may gather and analyze data regarding entire markets and business opportunities. This data may be used to develop strategic plans for enhancing business relationships with existing strategic customers and for developing plans to locate and develop new strategic customers. Still further, such strategic customers may be a source of information for the business enterprise to understand the strengths and weaknesses in the present business relationship. The customer itself may be encouraged to provide feedback information or may desire the ability to rapidly acquire status of planned projects with the business enterprise.

As presently practiced, each of these entities involved in such business relationships have gathered, managed and analyzed their required data largely in a vacuum devoid of automated interaction with other entities. Executives may for example manually gather the data they prefer for analysis of account representative performance as well as information regarding the entire enterprise performance. Business analysts and planners may independently develop business plans based on data they gather and manage independent of the executive level review data. Still further, an account manager may have yet another set of data gathered and managed as relevant to day-to-day interaction with the strategic customer. In addition, strategic customers may have significant feedback information valued by all entities that serve the strategic customer within the business enterprise.

Such gathering and management of strategic customer data by independent, largely manual means presents problems in that each entity may perform their respective task based upon analysis of different data—based on different assumptions about particular strategic customers, about particular marketplaces, etc. Though these various disparate entities within a business enterprise may physically store their respective gathered data within a common enterprise computing environment, they do not, at present, have the ability to effectively share the gathered data, analytical results and customer feedback. Further, due to lack of such data sharing capabilities, the various users cannot effectively collaborate to jointly generate data, establish goals, evaluate progress toward goals, receive and evaluate customer feedback, etc.

It is evident from the above discussion that a need exists for a more effective method and structure for collaborative efforts between various entities of a business enterprise and strategic customers of that enterprise.

### SUMMARY OF THE INVENTION

The present invention solves the above and other problems thereby advancing the state of the useful arts, by providing methods and associated structure for enabling effective collaborative efforts in interactions with a strategic customer and internal planning and management of such strategic customers within a business enterprise. More specifically, the present invention provides methods, structures and associated user interface techniques to enable more effective sharing of information for collaboration between entities within a business enterprise to manage strategic customer information and for interactions with such strategic customers.

One aspect of the invention provides for a central repository for storing strategic customer information associated with a plurality of strategic customers; a planning template to permit a plurality of users to share access to the strategic customer information through workstations coupled to the central repository such that the planning template includes a plurality of information zones defining related portions of the strategic customer information; and a customizable view of each zone of the planning template.

Another aspect of the invention provides a method including the steps of: storing strategic customer information in a central repository of a business enterprise; and presenting the strategic customer information on a user's display such that the information display is subdivided into a plurality of zones such that each zone includes a subset of related portions of the strategic customer information, and such that the information display is customizable by the user to select desired portions of the strategic customer data.

Yet another aspect of the invention provides a method including the steps of: retrieving strategic customer information corresponding to a select customer from a repository shared by multiple users; organizing the strategic customer information into a plurality of information zones such that each zone includes a related subset of the strategic customer information; presenting the plurality of information zones on a display screen; receiving requests from a user to update the strategic customer information; and storing the updated strategic customer information in the repository.

### BRIEF DESCRIPTION OF THE DRAWINGS

FIG. 1 is a block diagram of a system incorporating the features of the present invention.

FIGS. 2-7 are flowcharts describing methods associated with aspects of the present invention.

FIGS. 8-17 are exemplary computer screen displays associated with aspects of the present invention.

### DETAILED DESCRIPTION OF THE DRAWINGS

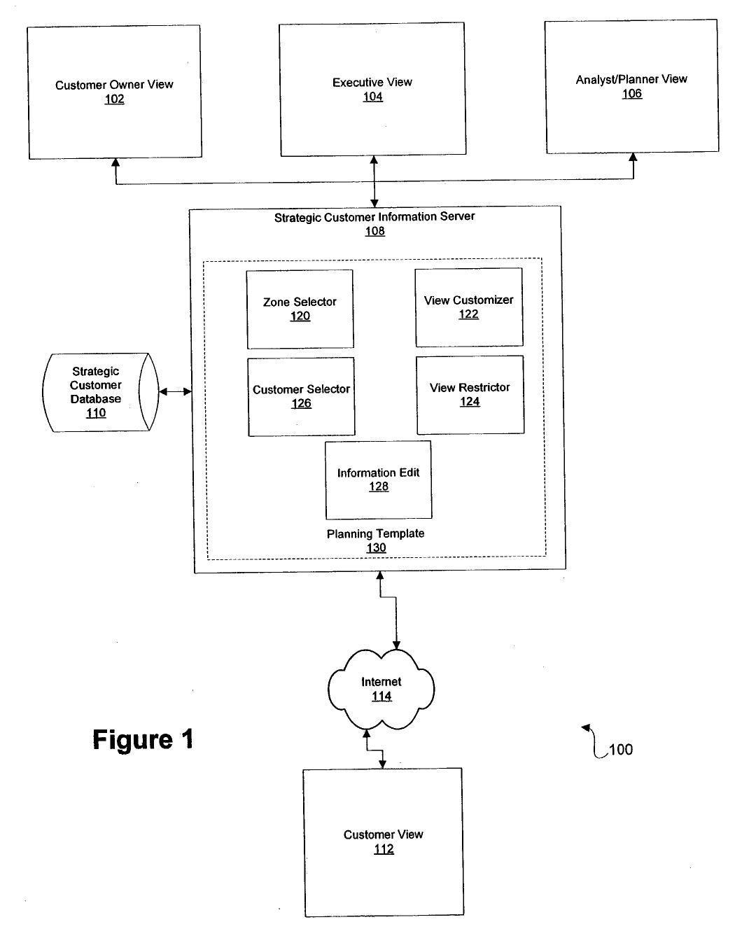

FIG. 1 is a block diagram of a system 100 incorporating strategic customer information management. A strategic customer information server 108 stores and retrieves strategic customer information in strategic customer database 110. Database 110 may be implemented utilizing hierarchical database management techniques, relational database management techniques, object-oriented database management techniques, and any of a variety of other well-known indexed file access techniques and systems readily apparent to those of ordinary skill in the art. Further, those of ordinary skill in the art will readily recognize that server 108 and a database 110 may be physically resident within a single computing system or may be distributed over any number of computing systems communicating via standard client/server interprocess communication techniques and media.

In a first aspect of the present invention, strategic customer information associated with a business enterprise may be managed, utilized, analyzed and otherwise manipulated by a plurality of entities within the business enterprise. As noted above, entities within a business enterprise that may benefit from utilization and management of strategic customer information may include a customer owner (also referred to herein as account manager), executives interested in evaluating overall goals and objectives of the entire business enterprise, business analysts developing strategic plans for particular existing market segments and/or customers as well as potential new customers and market segments. Those of ordinary skill in the art will readily recognize that any number of such business entities may be associated with a particular business enterprise in accordance with the common practices of such a business enterprise. The above identified list of common entities is therefore merely intended as exemplary of typical entities associated with management, manipulation, entry and analysis of data associated with strategic customer relationships of a business enterprise. Further, it is often valuable for strategic customers to directly interact with systems of such a business enterprise to achieve direct collaboration between the strategic customer and representatives and entities within the business enterprise.

Each of the various entities within a business enterprise as well as strategic customers interacting collaboratively with such business entities may manipulate, analyze and view strategic customer information in their own preferred, personalized view of the data. A particular user's view is also referred to herein as a “dashboard,” suggestive of a benefit realized by the present invention whereby all relevant information vital to a particular user's purpose may be readily viewed in a concise, standardized, canonical format. The collection of systems, processes and various views of shared, strategic customer information depicted as system 100 collectively defines a “collaborative workspace” for collaborative efforts associated with strategic customer relationships for a business enterprise.

As shown in FIG. 1, each type of entity associated with the business enterprise has a preferred view of the shared strategic customer information centrally located and managed by the strategic customer information server 108. Each view represents a user interface appropriate to the particular user and/or type of user. The user interface is bidirectional in that information is formatted and presented to the user by processes operable on server 108 (and/or operable within the user's workstation) and information is generated by the user through his/her view and returned to server 108 for persistent storage and sharing with other users. The customer owner view 102 represents the display of strategic customer information most relevant to the customer owner entities within the business enterprise. The customer owner entity is generally responsible for overall management of one or more strategic customers of the business enterprise and has the most direct interaction with the strategic customers. The customer owner may often be referred to as an account manager or account representative. Such an account manager (customer owner) may have primary responsibility for entering and maintaining strategic customer information regarding each of the strategic customers managed by the particular customer owner entity. In addition, as noted further herein below, the customer owner entity may also control which data elements are permitted data for viewing by the strategic customer.

An executive within a business enterprise may be interested in overall, higher level aspects of the strategic customer relationship. For example, an executive may be interested primarily in particular goals and quantitative or qualitative measures associated with achievement of those goals as reflected in the shared strategic customer information. Executive view 104 of FIG. 1 therefore represents such a view of the shared strategic customer information as may be most relevant to such an executive entity.

A business analyst or planner within a business enterprise may be focused on still other information associated with a particular strategic customer or a number of strategic customers associated with a particular market segment. Analyst/planner view 106 represents such a customized view of the shared strategic customer information as may be useful to an analyst or planner entity within a business enterprise.

As discussed further herein below, executives and analysts/planners may find value in viewing strategic customer information relating to multiple strategic customers of the business enterprise. An executive may, for example, need to analyze performance of a particular customer owner (account manager) as regards multiple customers with which that owner relates. Or, for example, a business analyst may wish to analyze data related to multiple strategic customers to better understand trends or issues relating to an entire market segment as distinct from a single customer. Such multiple customer views may therefore be provided such users to allow such higher level analysis of markets and/or business performance.

The strategic customer itself may also be a party to the collaborative efforts involving the shared access to the strategic customer information. Customer view 112 represents a particular view of the shared strategic customer information as may be useful to collaborative efforts including the particular strategic customer. For example, a strategic customer may query the strategic customer information to determine schedules or status associated with ongoing projects between the strategic customer and the business entity. Or, for example, the strategic customer may enter information into the collaborative workspace including, for example, customer feedback regarding elements of the overall relationship with a business enterprise.

As shown in FIG. 1, views associated with a customer owner entity (dashboard 102), an executive entity (dashboard 104), an analyst or planner entity (analyst/planner dashboard 106) may be presented on personal computers or workstations communicatively coupled to the strategic customer information server 108. Those of ordinary skill in the art will recognize that such user processes may be coupled to server 108 through intra-enterprise networks or through external networks such as the Internet or other so-called wide area networks (WANs) and virtual private networks (VPNs). Well-known client/server programming techniques may be applied to communicate information between such workstations and the centralized server including, for example, remote procedure calls (RPC), Web client/server interaction using HTTP Internet protocols, etc. Processes operable on the server 108 may include a number of features to group strategic customer information into a number of zones of related information and features to permit users to customize the view of that data. Each zone presents related elements of information relevant an aspect of customer account management. The various processes depicted in FIG. 1 as aspects of the server 102 permit a user, among other things, to select particular zones of information for display, to modify the data associated with the displayed zone, to customize the display by selecting which elements of data in the zone are to be displayed, etc.

The collection of such processes along with the organization of data into a plurality of related zones may be referred to as a planning template 130 in that the information presented enables standardized planning techniques to be applied to customer development and customer relation management to thereby enhance quality of such customer interactions. Use of such a standardized planning template enhances quality of the customer account management process. Standardized fields organized into a plurality of standard zones help improve data integrity. Further, by allowing multiple users to share the standardized data, more effective collaboration is enabled to further improve quality of customer account management within a business enterprise.

In particular, Zone Selector 120 is an element that permits a user of the system to select from among the plurality of zones the zone that is presently of interest in the user's interaction. View customizer 122 allows a user to customize the particular fields of information to be displayed within a selected zone. Information edit 128 allows presently displayed information to be modified by the user. Customer selector 126 allows a user to select one or more customer about whom strategic information is to be presented and/or modified. As discussed further herein below, certain users such as executives or analysts may benefit from viewing multiple customers on a single display. Such aggregated information derived from selection of multiple customers for viewing may be relevant to reviewing performance of a customer owner as regards multiple accounts under management, or for viewing trends or projections relating to broader market segments. View restrictor 124 allows a user (such as a customer owner/account manager) to restrict the fields of information permitted for a customer to view when a customer accesses the collaborative system.

As noted above, such processes may all be operable within a single computing system or may be distributed over a variety of computing systems coupled via network communication media. Any of a variety of well-known network communication media and protocols may be utilized for such distributed computing architectures as is well-known in the art including, for example, TCP/IP protocols over local area networks on Ethernet media. In like manner, as shown in FIG. 1, the customer view (customer dashboard 112) may be presented to a strategic customer through a personal computer or workstations coupled to the strategic customer information server via an Internet connection 114 (or other WAN, VPN or intra-network connections). Those of ordinary skill in the art will readily recognize that all such dashboards and views may be presented on computing systems coupled to the strategic customer information server via any of several well-known computer communication protocols, media and architectures including, for example as above, Ethernet media running TCP/IP protocols over local area networks coupling individual PCs or workstations to one or more servers. Any of the various views may be provided via a wide area networks such as the Internet and/or via local area networks physically co-resident within a business enterprise. Application of such localized and distributed computing paradigms is well known to those of ordinary skill in the art. Further, application of well-known client/server technologies as noted above may be utilized to standardize the desired interaction between such personal computers and workstations and the centralized, strategic customer information server.

In one aspect of the invention, all such views (dashboards) may be presented to users by utilizing well-known Web browser client programs and associated protocols. Web browsers have evolved to become de facto standard user interface vehicles through which such customized displays and views may be readily implemented. Further, in addition to Web browser interfaces, any number of other well-known graphical user interfaces may be applied to generate the desired customized views (dashboards) for each of a plurality of users associated with the collaborative efforts in shared strategic customer information.

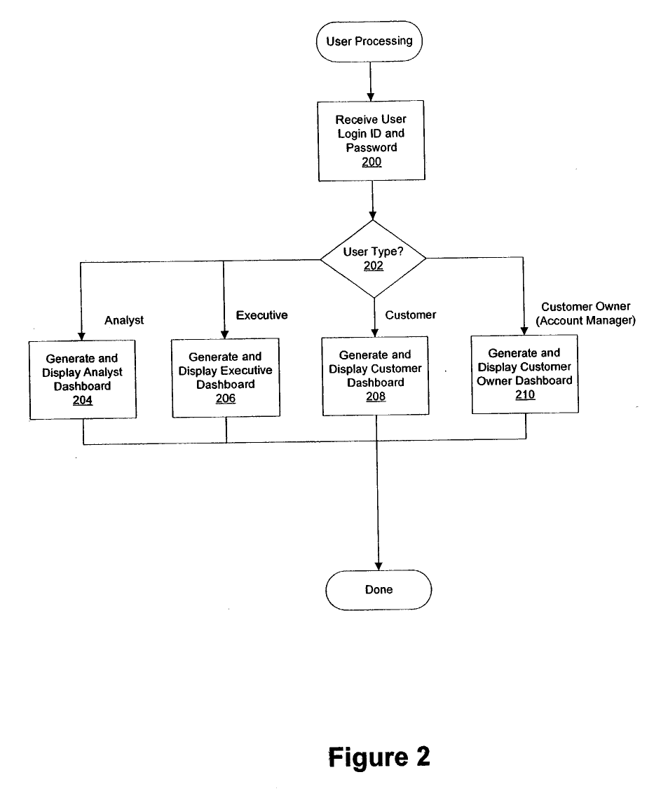

FIG. 2 is a flowchart describing the overall interaction with the user of the dashboard features of the present invention that present the planning template to a user. In one aspect of the invention, user login features are provided to secure access to the centralized, shared strategic customer information server and database. An initial login screen requests the user ID and associated password to authenticate the user of the system. Those of ordinary skill in the art will recognize a wide variety of such authentication techniques may be applied to maintain any particular level of desired security for the business enterprise as a whole and, more specifically, for the shared, strategic customer information. Element 200 therefore receives user input identifying the user and supplying associated password. Upon authentication of the supplied user and password information, element 202 is next operable to identify the user type of the user ID just logged in. As noted above, any number of user types may be associated with the collaborative efforts to manage, enter, analyze and share strategic customer information. Exemplary user types include business analyst/planner, management executive, customer owner or account management representative and, at the discretion of the business enterprise, strategic customers may be permitted access to the collaborative workspace of the shared strategic customer information. If element 202 determines that the logged in the user is a business analyst, element 204 represents appropriate processing to provide the desired customized view (dashboard) associated with such a business analyst's requirements. If element 202 determines that the logged in user type is that of a management executive, element 206 is operable to presents an appropriate dashboard view for the logged in executive. Its element 202 determines that the logged in user type is an external strategic customer, an appropriate dashboard view is presented to such a customer entity as represented by element 208. Further, if the element 202 determines that the logged in user type is a customer owner (account manager), element 210 is operable to present an appropriate customized dashboard (view) for manipulation of the shared strategic customer information by the customer owner.

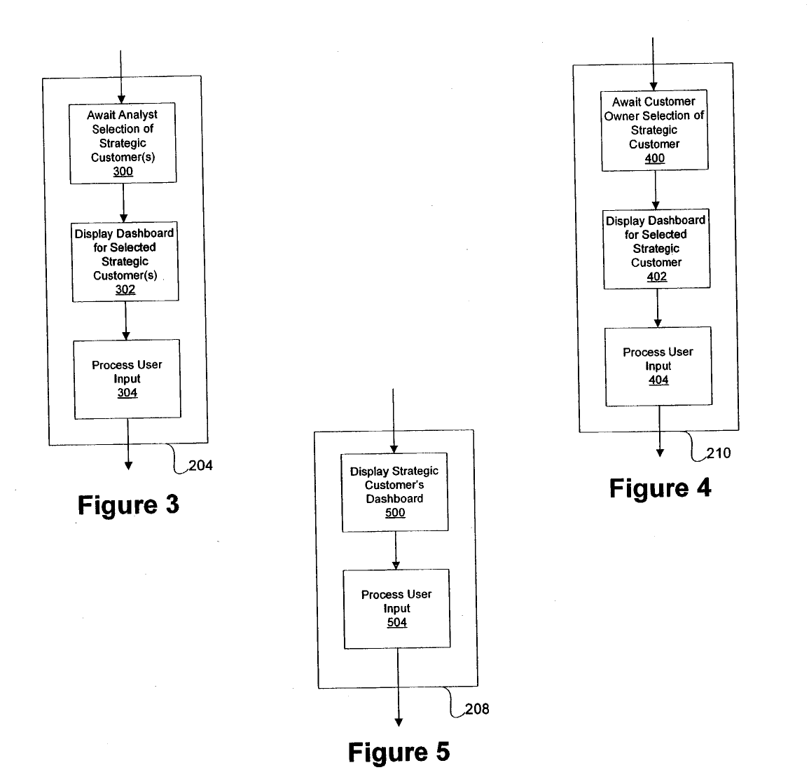

As noted above, any number of user types may be associated with the present invention in accordance with the needs of a particular business enterprise, industry, or market. The particular user types discussed above and presented in FIG. 2 in relation to processing of elements 204 through 210 are therefore merely intended as exemplary of typical business entities associated with strategic customer relationships in a business enterprise. Flowcharts of FIGS. 3 through 7 discussed further herein below provide additional details of the operations associated with processing to present a desired customized dashboard (view) for each of the exemplary user types.

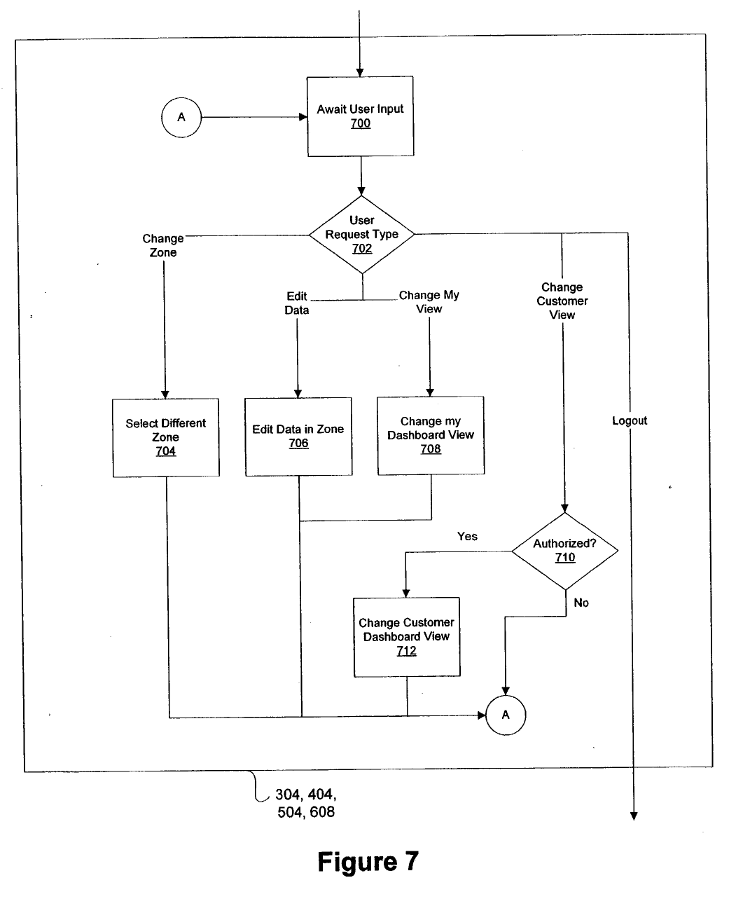

FIG. 3 is a flowchart providing additional details of exemplary processing of element 204 above for initiating a dashboard view presentation for an analyst/planner entity of a business enterprise. Element 300 awaits selection by the analyst of a particular strategic customer(s) for which analysis is to be performed. Those of ordinary skill in the art will readily recognize that such selection input may be provided by a user through keyboard entry of a desired strategic customer identifier, use of a pointer device to select from a menu of available strategic customers, or any other user interface technique readily apparent to those of ordinary skill in the art. Upon selection of a desired strategic customer for which analysis is to be performed, element 302 is next operable to display the analyst/planner's dashboard view of strategic customer information for the selected strategic customer. Element 304 is operable to process further input from the analyst/planner whereby the analyst identifies particular data to be viewed and/or modified, and particular analysis techniques to be applied thereto. Further details of processing of element 304 are provided herein below with respect to FIG. 7.

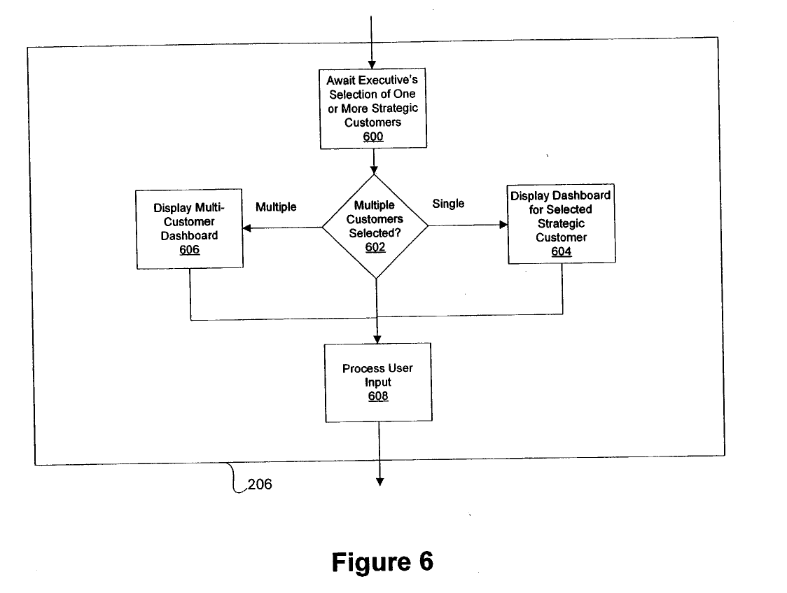

Additional details of methods for allowing selection of multiple customers and for display of information relating to multiple selected customers is provided herein below with respect to FIGS. 6, 16 and 17. Analysts may desire selection of multiple customers to observe trends relating to multiple customers or to entire markets relevant to the business enterprise.

FIG. 4 is a flowchart providing additional details of exemplary processing of element 210 above, for initiating a dashboard view presentation for a customer owner entity of a business enterprise. Element 400 first awaits selection by the customer owner of a particular strategic customer (managed by the customer owner) for which shared data review and/or management is to be performed. Those of ordinary skill in the art will readily recognize that such selection input may be provided by a user through keyboard entry of a desired strategic customer identifier, use of a pointer device to select from a menu of available strategic customers, or any other user interface technique readily apparent to those of ordinary skill in the art. Upon selection of a desired strategic customer for which management of strategic customer information is to be performed, element 402 is next operable to display the customer owner's dashboard view of strategic customer information for the selected strategic customer. Element 404 is operable to process further input from the customer owner whereby the customer owner identifies particular data to be viewed and/or modified. Further details of processing of element 404 are provided herein below with respect to FIG. 7.

FIG. 5 is a flowchart providing additional details of exemplary processing of element 208 above for initiating a dashboard view presentation for use by the strategic customer, per se. As noted above, the shared strategic customer information essentially defines a collaborative workspace that may include direct interaction with the strategic customer. The dashboard view for the strategic customer may be configured and defined by the customer owner as described further herein below. When the user login is identified as a customer (as distinct from an internal entity of the business enterprise), the customer's dashboard is immediately presented with information associated with that strategic customer. Element 500 therefore represents processing to display the strategic customer's dashboard view as presently defined and configured by the customer owner. Element 504 is operable to process further input from the customer whereby the customer may view information associated with its relationship with the business enterprise and may enter additional information including, for example, customer feedback information pertaining to the status and/or quality of the relationship with the business enterprise.

FIG. 6 is a flowchart providing additional details of the operation of element 206 above to present a dashboard view appropriate to a logged-in executive of the business enterprise. As noted above, an executive of the business enterprise may interact through the collaborative workspace to evaluate qualitative and quantitative aspects of the business relationship between the business enterprise and one or more of its strategic customers. Exemplary of such analysis may be evaluation of quantitative performance measures in the business relationship relative to established goals for the business relationship. Further, the executive may perform analysis of qualitative aspects of the relationship with one or more to strategic customers. Qualitative aspects of the business relationship may include, for example, review of customer feedback and/or tracking of information related to particular customer problems.

As noted, such an executive entity of a business enterprise may also derive value from analysis of multiple strategic customers in a single dashboard view. Such a multi-customer dashboard view may more readily permit comparative analysis of the business relationship between the business enterprise and multiple, similarly situated strategic customers. For example, an executive may desire analysis of all strategic customers associated with a particular market or business in which the business enterprise is engaged. Or, for example, an executive may wish to review all customers that are managed by a particular customer owner (account manager) to observe performance of that account manager. As noted above with respect to FIG. 3, similar processing may be useful to an analyst user to allow an analyst to review information relating to multiple strategic customers.

Element 600 is first operable to await input from the executive user indicating a selection of one or more strategic customers for which analysis is desired. As noted above, any of a variety of user interface techniques well-known to those of ordinary skill in the art may be utilized to receive input from the executive user indicating the desired one or more strategic customers for review and analysis. Element 602 is operable to determine whether the executive user has selected a single strategic customer for analysis or multiple strategic customers for comparative analysis. If the executive user has selected a single strategic customer for further analysis, element 604 is next operable to display the customized dashboard view for executive analysis of a single strategic customer. Processing and continues at element 608 as described further herein below. If element 602 determines that the executive user has selected multiple strategic customers for comparative analysis, element 606 is operable to display the multi-customer dashboard with the selected multiple strategic customers information included therein. Element 608 then continues by processing further input from the user as described further below.

FIG. 7 provides additional details of exemplary processing of further user input in as described above with respect elements 304, 404, 504 and 608. As noted above, following initial display of the desired, customized, dashboard view, further user input is received to request particular operations related to the dashboard view. The dashboard view provides a set of operations that may be performed in a controlled manner to assure consistency in the structure and content of the shared strategic customer information. Such consistency helps improve the integrity of the shared data permitting multiple entities within the business enterprise, as well as each of a plurality of strategic customers of the business enterprise, to collaborate in the sharing of critical information relating to the business relationship. As noted above, such information may include quantitative aspects of the business relationship as well as qualitative aspects thereof. Analysis of both quantitative and qualitative measures of business relationship may therefore be performed in this collaborative workspace using information in a standardized, canonical format.

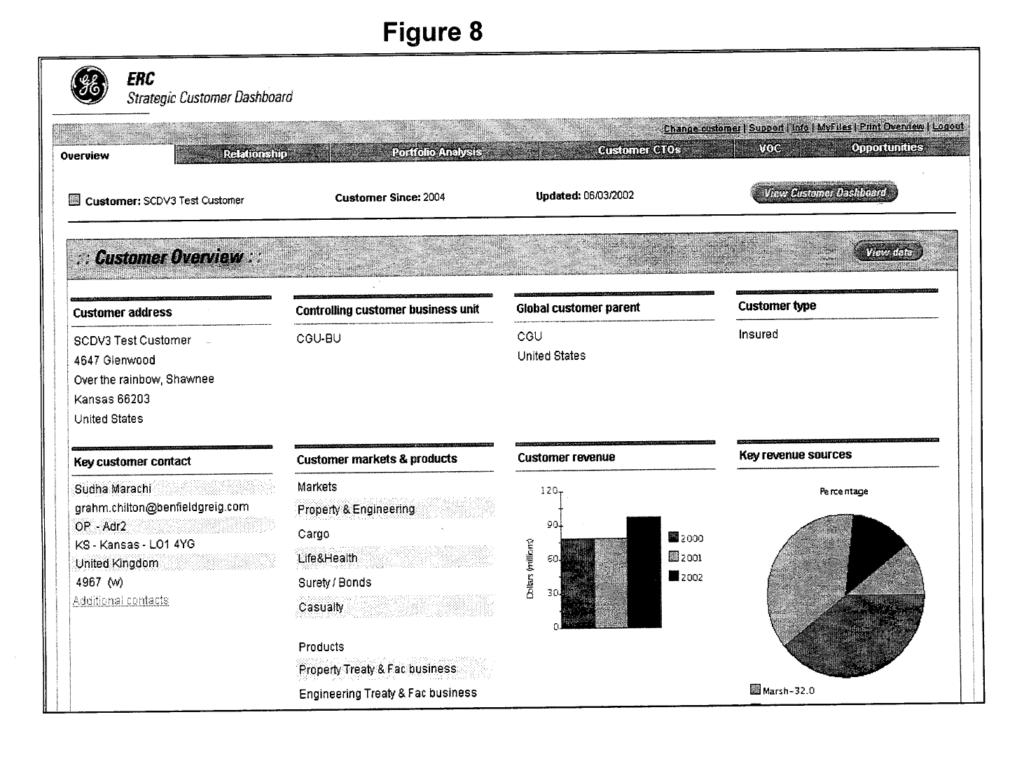

Element 700 of FIG. 7 awaits a next user input. As noted above, any number of standard operations may be requested through the dashboard interface. User input may include keyboard input, voice command input, pointer device input, etc. Upon receipt of such user input, element 702 is next operable to determine the type of operation requested by the user through the dashboard view presented on the user's display screen. If the user input received by element 700 is determined by element 702 to be a logout request by the user, processing completes returning to the methods depicted and described above. If element 702 determines that the user input has requested display of a different zone of data, element 704 is next operable to switch the dashboard display to a different zone of data. As noted above, and as discussed in further detail herein below, a dashboard view may include a number of standard zones of data to organize strategic customer data into common categories for standardized forms of analysis, viewing and data entry. Further details of potential grouping of zones of data and associated screen displays are discussed herein below with reference to FIGS. 8 through 17.

If element 702 determines that the user input has requested the editing of data in the presently displayed zone, element 706 is next operable to process the request and effectuate the edits as indicated by the user's input. As noted above and discussed further herein below, in any particular zone of data presently displayed on the user's dashboard view, a properly authenticated and authorized user may modify the data presently displayed on the dashboard view. Those of ordinary skill in the art will recognize that each user may be provided with an appropriate level of access that may allow or preclude requested editing of particular portions of data. Such security features are well-known to those of ordinary skill in the art and need not be discussed further herein. Examples of such data editing displays and associated user input are provided herein below with reference to FIGS. 8 through 17.

If element 702 determines that the user input has requested a change to the layout or content of the user's dashboard, element 708 is next operable to process further user input to reconfigure the user's dashboard view. As noted above and discussed further below, the particular elements of strategic customer information to be displayed in any particular zone may be customizable by the user. Further, as noted above and discussed further below, the customer owner (account manager) within the business enterprise may enable particular features to be configured by a strategic customer user external to the business enterprise. Such a strategic customer user may therefore customize its dashboard view only within the parameters permitted by the customer owner within the business enterprise. Examples of typical dashboard displays associated with such request to change the dashboard configuration are discussed further herein below with reference to FIGS. 8 through 17.

If element 702 determines that the user input has requested a change to the customer's dashboard view configuration, element 710 is first operable to determine whether or the requesting user has appropriate authority to make such a configuration change. If so, element 712 is next operable to effectuate the desired change in the customer's dashboard view. As noted above and discussed further herein below, the customer owner entity within the business enterprise may restrict a strategic customer's dashboard view to particular data values defined within each of the multiple zones of the dashboard. A properly authorized customer owner user may therefore alter the limits defining what strategic customer information may be shared with the strategic customer outside the business enterprise. Exemplary dashboard displays and associated user input for effectuating such changes are discussed further herein below with regard to FIGS. 8 through 17.

The methods described above comprise processing aspects of the planning template that enables standardized collaborative customer account management for users in a business enterprise. Those of ordinary skill in the art will readily recognized that the methods presented herein with respect to FIGS. 2 through 7 are intended merely as representative of one exemplary embodiment providing the features and benefits of the present invention. Numerous equivalent techniques and associated structures will be readily apparent to those of ordinary skill in the art.

FIGS. 8 through 17 represent exemplary screen displays of typical dashboard view displays associated with presentation of the planning template aspects of the present invention. As noted above, such displays may be presented on Web browser client programs communicatively coupled with an associated server maintaining centralized control of the strategic customer information. Those of ordinary skill in the art will readily recognize a variety of programming techniques and structures whereby such exemplary screen displays may be presented to a user.

FIG. 8 is an exemplary dashboard view presenting a first zone of data of the planning template representing an overview of the key data on critical facets of the customer's business environment. As noted above, such a dashboard view may include one or more zones of strategic customer information. Each such zone represents a group of related factors relevant to various entities of the business enterprise for purposes of data entry, management and analysis. As shown in FIGS. 8 through 17, six zones may be represented on such a dashboard display. Exemplary zones as shown may include an Overview zone, a Relationship Summary zone, a Portfolio Analysis zone, a Customer Critical to Quality zone (“CTQ”), a Voice of the Customer zone (“VOC”) and an Opportunities zone. Each such zone may be indicated by a hyperlinked tab as depicted along the top portion of the dashboard display shown in, for example, FIG. 8.

The Customer Overview zone as exemplified in FIG. 8 may include the key data on critical facets of the customer's business environment, thus providing a quick overview of key aspects of the business relationship between the business enterprise and a selected strategic customer.

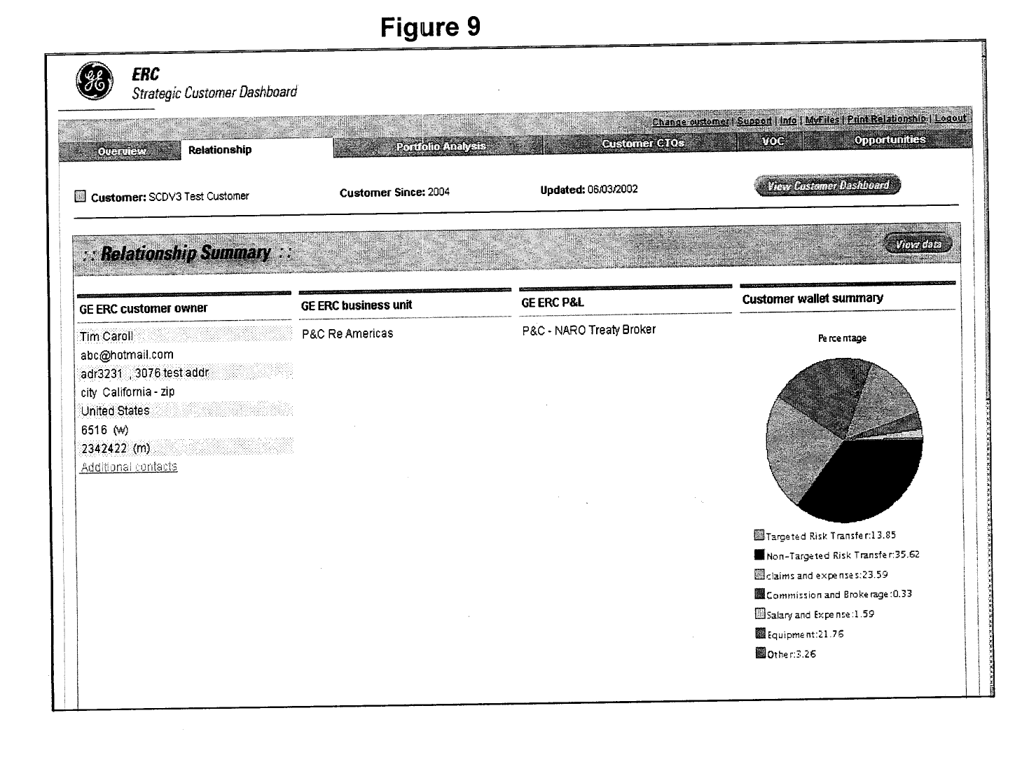

FIG. 9 shows an exemplary dashboard view where the user has selected the Relationship Summary zone tab. Information presented in the Relationship Summary zone of the planning template may include higher level information pertaining to the business enterprise's relationship with the customer.

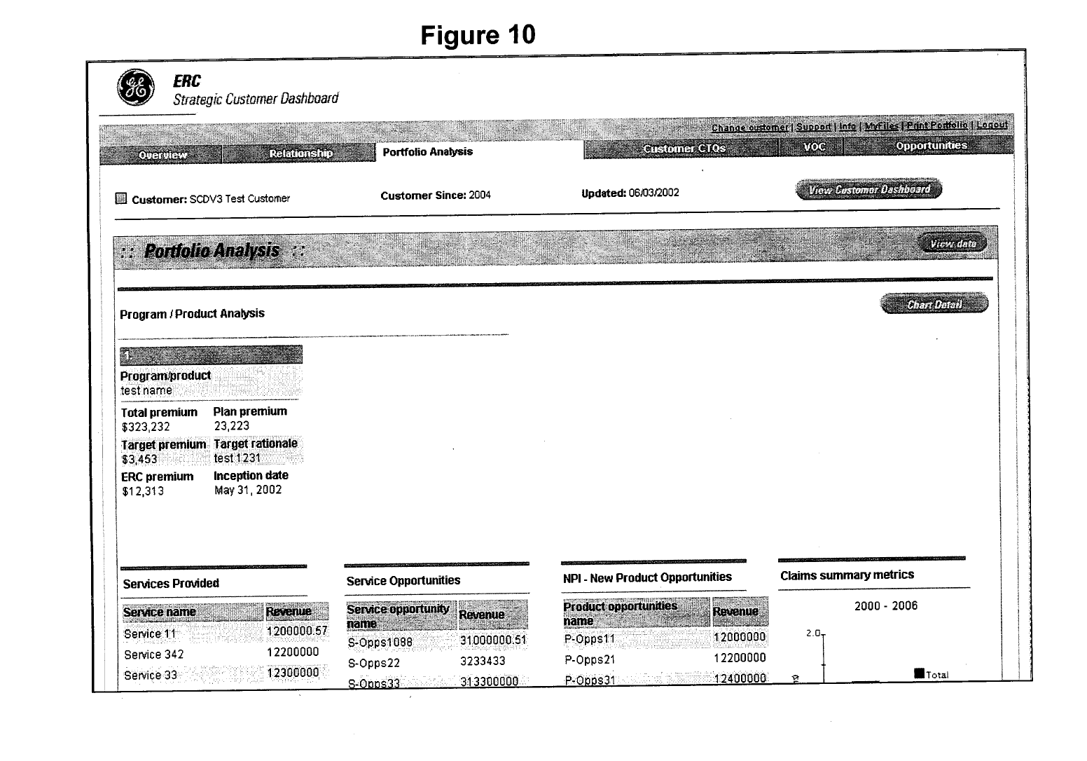

FIG. 10 is an exemplary dashboard view where the user has selected the Portfolio Analysis zone of strategic customer information. The Portfolio Analysis zone of the planning template may include, for example, a more detailed summary of the strategic customer's buying patterns relating to products and services provided by the business enterprise. Unmet needs of the strategic customer may be readily revealed on such a dashboard display screen.

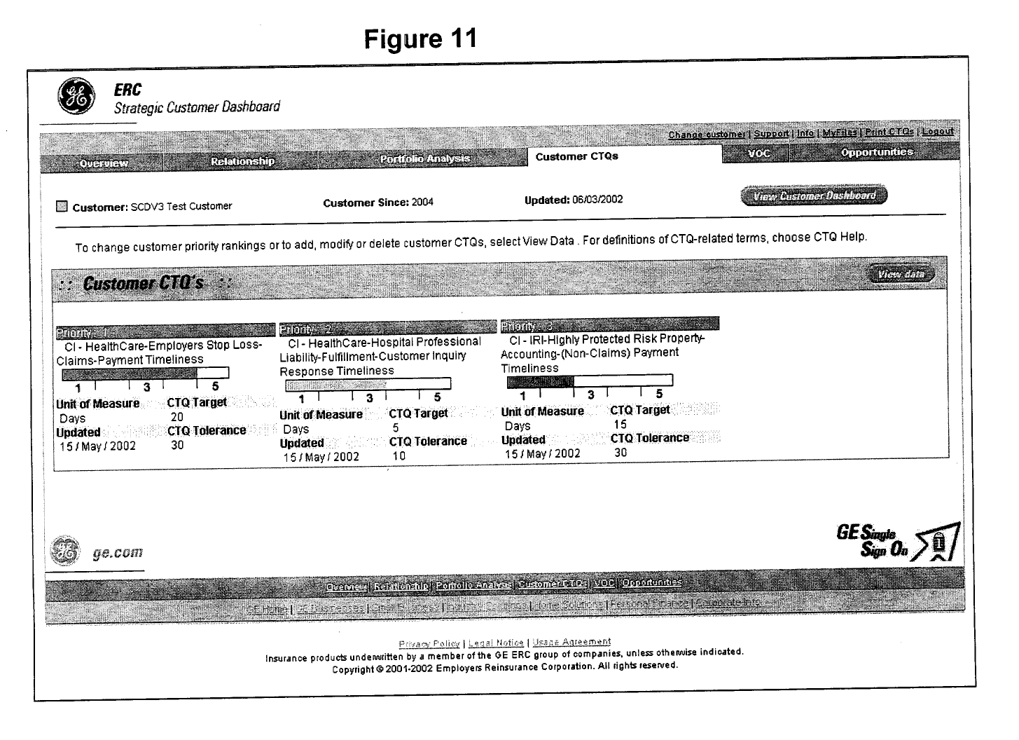

FIG. 11 is an exemplary dashboard view where the user has selected the CTQ zone of the planning template for display and analysis. Critical To Quality information relating to the strategic customer presents information regarding factors identified in the business relationship for the particular strategic customer identified as critical to quality of the business relationship.

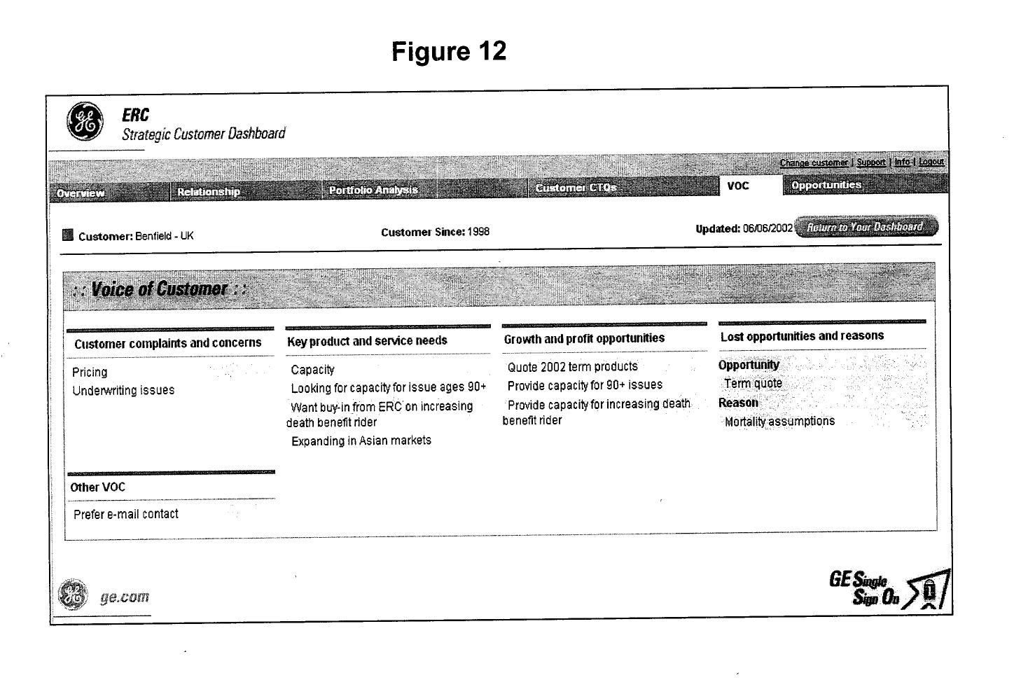

FIG. 12 is an exemplary dashboard view where the user has selected the Voice Of the Customer zone of strategic customer information. The Voice Of the Customer zone of the planning template may include specific feedback from the strategic customer regarding quantitative or qualitative aspects of the business relationship. In particular, the Voice Of the Customer zone of strategic customer information includes feedback data entered by the strategic customer utilizing the collaborative workspace. Such qualitative and quantitative input from the strategic customer may prove valuable to the business enterprise to maintain the quality of existing relationships, address specific problems identified by the strategic customer, and aid in identifying new business opportunities for the identified strategic customer.

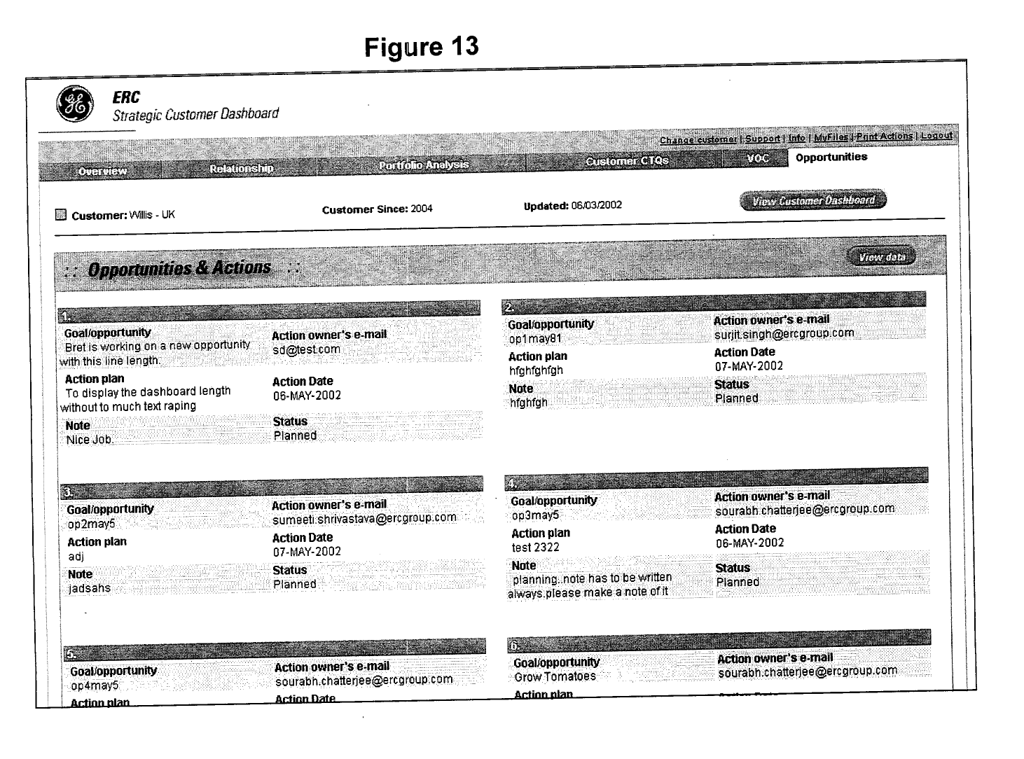

FIG. 13 is an exemplary dashboard view where the user has selected the Opportunities zone of strategic customer information for display, modification or analysis. The Opportunities zone of the planning template may include specific action plans to advance the business relationship as mutually agreed upon between the strategic customer and, for example, the customer owner. In general, specific goals and opportunities in advancing the business relationship or maintaining quality of the current business relationship may be identified in the Opportunities zone of strategic customer information. The collaborative workspace shared repository for such information aids in maintenance of quality of the business relationship.

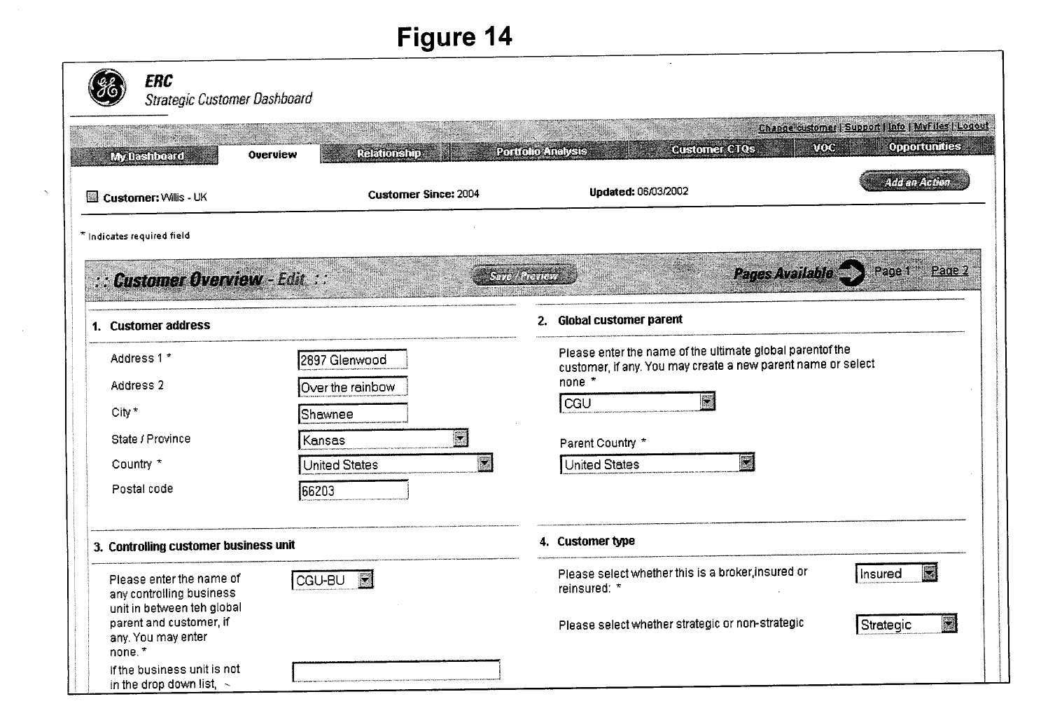

As described above, dashboard view screens present information to the user organized into one or more zones of related aspects of the strategic customer information. In addition to viewing the selected data, a properly authorized user may enter or modify the data associated with the strategic customer. FIG. 14 is an exemplary dashboard view screen displaying the Customer Overview zone of data as enabled for editing or modification by the user. Referring momentarily back to FIG. 8, when viewing the Customer Overview zone of data, a user may “click” the “view data” button on the display screen signifying the user's desire to view the raw data and optionally modify the data. Clicking a hyperlinked button in a Web browser is intended merely as exemplary of one possible user interface technique to permit a user to signify a desire to edit display data.

Referring again to FIG. 14, in response to the user's indication that viewing and editing of the data is desired, the Customer Overview zone of data is depicted in a mode that permits a properly authorized user to edit the entered data. As shown in FIG. 14, customer address information may be modified, parent company information may be modified, information regarding a controlling business unit may be entered, a type of customer may be identified, etc. Those of ordinary skill in the art will readily recognized that any number of such data fields may be presented to the user using appropriate scrolling or other display techniques to permit a larger volume of data to be reviewed by the user. When the user has completed any desired modifications to the displayed data, the user may click the “save/preview” button to signify acceptance of the data modifications.

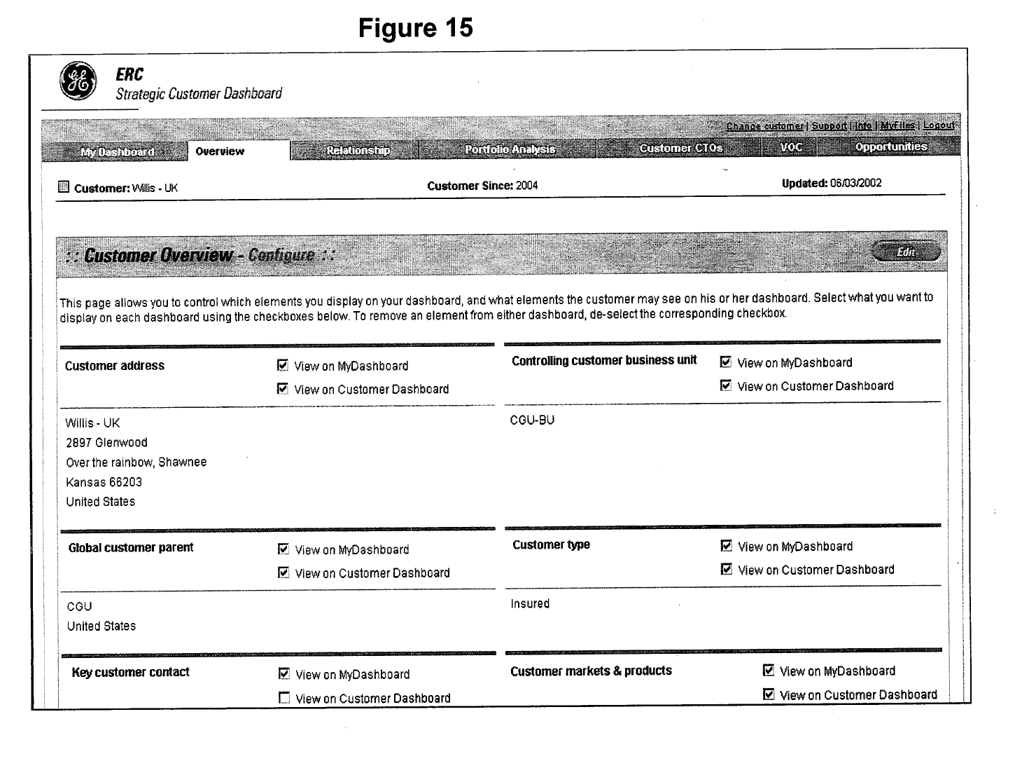

As noted above, a user may modify the selection of information to be presented on their personal, customized dashboard display. FIG. 15 is an exemplary dashboard display whereby a user is permitted to configure the dashboard display for information to be viewed in the Customer Overview zone of the user's personalized, customized dashboard display. All available standard data elements of the strategic customer information grouped in the Customer Overview zone are presented on such a display screen with check boxes or other user interface indicia modified by the user to customize their personal dashboard display for the Customer Overview zone. By checking the box indicating the data element is to be viewed on “my dashboard”, the user may configure their personal dashboard preferences. A properly authorized user, such as the customer owner user associated with a particular strategic customer, may also customize the information to be presented to the strategic customer if and when the customer is permitted to login to the business enterprise dashboard system. The customer owner may check boxes as depicted on FIG. 15 to indicate that the associated data element is to be viewed on the customer's dashboard. A customer user logged in to the enterprise may then select among those data elements permitted to be viewed in accordance with the customer owner's configuration of the customer's dashboard.

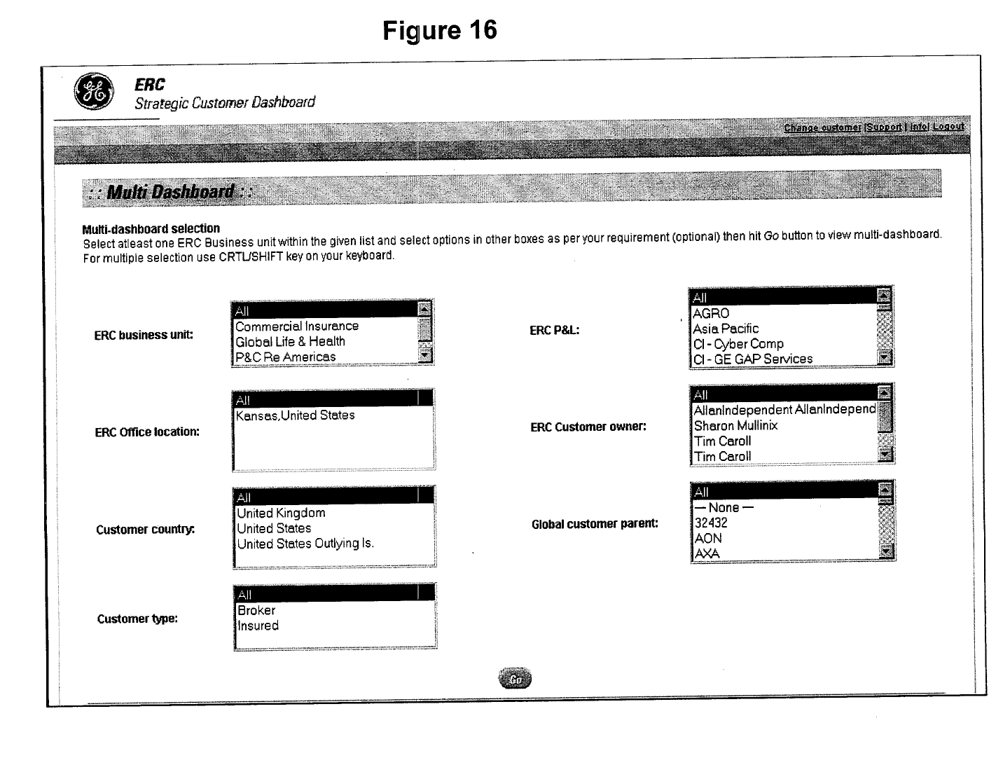

As noted above, and executive user (as well as other users if so desired) may wish to configure a multi-customer dashboard configuration. Executive users in particular may wish to view comparative information for all strategic customers associated with a particular business unit of the larger business enterprise or, for example, all strategic customers associated with a particular location of the business enterprise, etc. A multi-customer dashboard configuration screen exemplified by FIG. 16 permits a user (such as an executive user) to select strategic customers associated with particular attributes of the business enterprise. Examples of such attributes as depicted in FIG. 16 may include particular business unit affiliations, particular office location affiliations, particular countries, etc. Those of ordinary skill in the art will readily recognize a variety of such business enterprise attributes that may be referenced to identify groups of multiple customers to be viewed on a multi-customer dashboard.

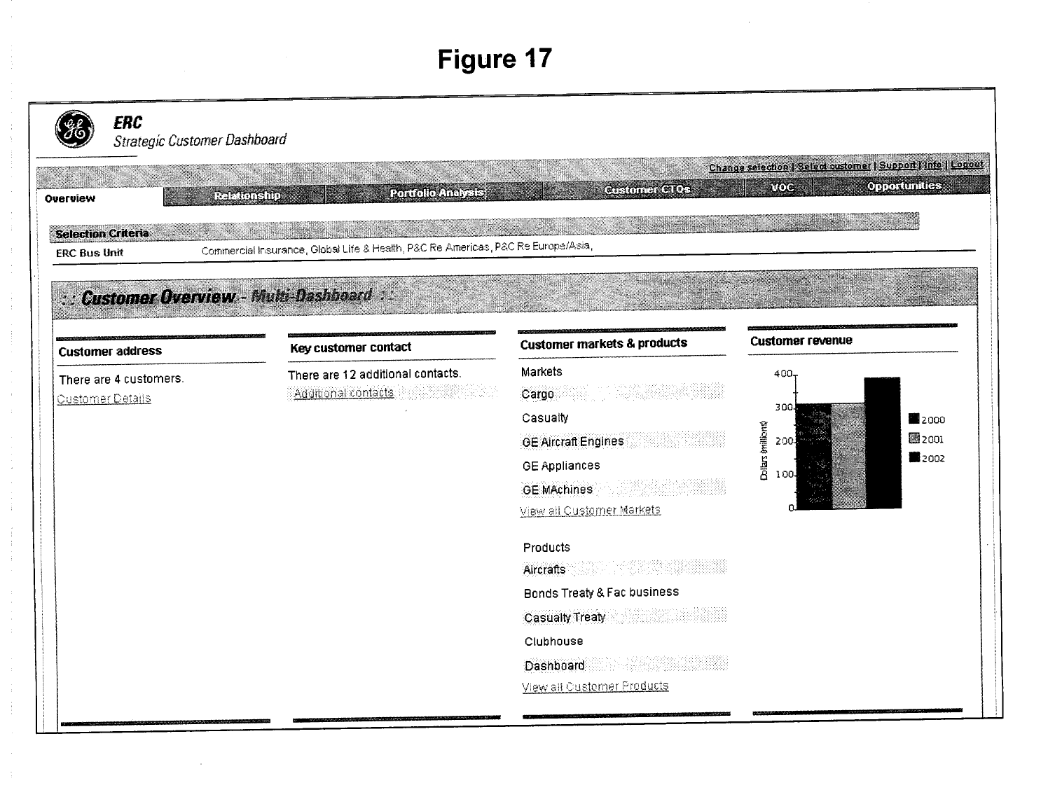

FIG. 17 depicts an exemplary dashboard display corresponding to a multi-customer dashboard selection as described above with respect to FIG. 16. Having so selected appropriate attributes to define a group of strategic customers, the display exemplified by FIG. 17 then aggregates the display of information for all strategic customers qualifying with the selected multi-customer configuration described above with respect to FIG. 16.

As noted above, the distribution of the strategic customer data into related zones and the processes to manage and display those zones of strategic customer information are elements of a planning template that, when used by multiple users, defines a collaborative workspace for customer account management. This planning template improves quality of customer account management and associated customer interaction for a business enterprise. The particular zones of the planning template help guide the user through processes that improve customer interaction and provide accountability for desired or required interactions. Multiple users applying the planning template for management of one or more customers defines, in effect, a collaborative workspace for improved quality of customer account management and customer interaction. Those of ordinary skill in the art will readily recognize that any number of similar screen displays may be used to convey similar information to users of such a dashboard display environment. Aspects of the present invention provide a framework including a customizable dashboard configuration for multiple user types associated with a business enterprise and strategic customers doing business with that business enterprise. The collaborative workspace so defined permits simplified sharing of information through a standardized interface thereby enabling more robust configuration and utilization of such collaborative shared information pertaining to strategic customer relationships of a business enterprise. Numerous equivalent display configurations will be readily apparent to those of ordinary skill in the art. The screen displays of FIGS. 8 through 17 are therefore intended merely as exemplary of a subset of possible screen displays associated with such a customizable dashboard architecture.

What is claimed is:

1. A collaborative customer account management system comprising:
a shared storage subsystem for storing strategic information relating to strategic customers of a business enterprise;
a plurality of workstations coupled to said shared storage subsystem for generating information to be stored on said shared storage subsystem and for retrieving information previously stored on said shared storage subsystem; and
a user interface component associated with each workstation of said plurality of workstations for providing a customizable user interface to a user of said information; and
a standardized account planning template to enable multiple users to access different subsets of said strategic information as appropriate to a type attribute associated with each user of said multiple users,
wherein said standardized account planning template includes:
a plurality of information zones wherein each information zone of said plurality of information zones includes related portions of said strategic information.

2. The system of claim 1 wherein said type attribute of said each user is selected from the group consisting of: customer, customer owner, executive and analyst.

3. The system of claim 1 wherein said standardized account planning template includes:
a view customizer to permit said each user to customize said each view of said strategic information to create a custom view of said strategic information.

4. The system of claim 3 wherein said type attribute of said each user is selected from the group consisting of: customer, customer owner, executive and analyst.

5. The system of claim 4 wherein said view customizer includes:
a view restrictor to permit a customer owner type user to restrict the portions of said plurality of available portions that may be selected by a customer type user.

6. The system of claim 1 wherein said standardized account planning template includes:
a zone selector to permit said each user to select from among said plurality of information zones of said standardized account planning template.

7. The system of claim 1 wherein said plurality of information zones includes at least one of:
a Customer Overview zone;
a Relationship Summary zone;
a Portfolio Analysis zone;
a Critical-To-Quality zone;
a Voice Of The Customer zone; and
an Opportunities zone.

8. The system of claim 1 wherein said type attribute of said each user is selected from the group consisting of customer, customer owner, executive and analyst.

9. The system of claim 1 wherein said standardized account planning template includes:
a multi-customer view to allow a user to review said strategic information relating to multiple strategic customers.

10. A collaborative workspace for strategic customer management comprising:
a central repository for storing strategic customer information associated with a plurality of strategic customers;
a planning template to permit a plurality of users to share access to said strategic customer information through workstations coupled to said central repository wherein said planning template includes a plurality of information zones defining related portions of said strategic customer information; and
a customizable view of each zone of said planning template.

11. The workspace of claim 10 wherein said customizable view includes:
a customer selection element to select one or more customers for which strategic customer information is to be presented;
a zone selection element to select among said plurality of information zones wherein each zone includes related information elements of said strategic customer information;
a view selection element to select information fields for display from among information fields within a selected zone; and
an information edit element to permit user modifications to selected information fields.

12. A method for managing strategic customer information relating to one or more strategic customers of a business enterprise, the method comprising the steps of:
storing said strategic customer information in a central repository of said business enterprise; and
presenting said strategic customer information on a user's display wherein the information display is subdivided into a plurality of zones such that each zone includes a subset of related portions of said strategic customer information, and wherein the information display is customizable by the user to select desired portions of said strategic customer data.

13. The method of claim 12 further comprising:
selecting one zone of said plurality of zones in response to user input; and
displaying only portions of said strategic customer data stored in the selected said one zone.

14. The method of claim 13 further comprising:
customizing the display of said one zone on the user's display in response to receipt of user input.

15. The method of claim 14 wherein the step of customizing comprises:
selecting a portion of information stored in said one zone in response to receipt of said user input.

16. A business planning system comprising:
a shared repository for strategic customer information; and
a plurality of user workstations coupled to said shared repository wherein each workstation of said plurality of user workstations each operable to present a standardized planning template thereon to thereby provide access to said strategic customer information to a plurality of users.

17. The system of claim 16 wherein said template includes:
a plurality of information zones wherein each zone includes a subset of said strategic customer information.

18. The system of claim 17 wherein said plurality of information zones include:
a Customer Overview zone;
a Relationship Summary zone;
a Portfolio Analysis zone;
a Critical-To-Quality zone;
a Voice Of The Customer zone; and
an Opportunities zone.

19. The system of claim 16 wherein said template user interface includes:
a view customizer element to permit a user to select portions of said strategic customer information for display on the user's workstation.

20. The system of claim 19 wherein said template user interface further includes:
a customer selection element to permit said user to select one customer associated with said strategic customer information from which said portions are selected.

21. The system of claim 19 wherein said template user interface further includes:
a customer selection element to permit said user to select multiple customers associated with said strategic customer information from which said portions are selected.

22. In a business enterprise, a method for collaborative customer planning comprising the steps of:
retrieving strategic customer information corresponding to a select customer from a repository shared by multiple users;
organizing said strategic customer information into a plurality of information zones wherein each zone includes a related subset of said strategic customer information;
presenting said plurality of information zones on a display screen;
receiving requests from a user to update said strategic customer information; and
storing the updated strategic customer information in said repository.

23. The method of claim 22 further comprising:
verifying a login request from a user to permit authenticated user to access the repository; and
selecting said select customer in accord with input from the authenticated user prior to retrieving said strategic customer information corresponding to said select customer.

24. The method of claim 23
wherein the step of selecting comprises:
selecting multiple select customers, and
wherein the step of retrieving comprises:
retrieving said strategic customer information corresponding to all of said multiple select customers.

25. The method of claim 22 further comprising:
verifying a login request from a user to permit authenticated user to access the repository;
determining a user type associated with said authenticated user; and
selecting said select customer as the authenticated user in response to a determination that the authenticated user is associated with a customer user type prior to retrieving said strategic customer information corresponding to said select customer.

26. The method of claim 22 further comprising:
selecting, in response to input from a user, a current zone for display from said plurality of information zones,
wherein the step of presenting comprises:
displaying said current zone on said display screen.

27. The method of claim 26 further comprising:
selecting, in response to input from a user, selected fields of said strategic customer information in said current zone,
wherein the step of displaying said current zone comprises:
displaying said selected fields of said current zone on said display screen.

28. A computer readable storage medium tangibly embodying program instructions for a method for managing strategic customer information relating to one or more strategic customers of a business enterprise, the method comprising the steps of:
storing said strategic customer information in a central repository of said business enterprise; and
presenting said strategic customer information on a user's display wherein the information display is subdivided into a plurality of zones such that each zone includes a subset of related portions of said strategic customer information, and wherein the information display is customizable by the user to select desired portions of said strategic customer data.

29. The storage medium of claim 28 the method further comprising:
selecting one zone of said plurality of zones in response to user input; and
displaying only portions of said strategic customer data stored in the selected said one zone.

30. The storage medium of claim 29 the method further comprising:
customizing the display of said one zone on the user's display in response to receipt of user input.

31. The storage medium of claim 30 wherein the method step of customizing comprises:
selecting a portion of information stored in said one zone in response to receipt of said user input.

32. A computer readable storage medium tangibly embodying program instructions for a method for collaborative customer planning in a business enterprise, the method comprising the steps of:
retrieving strategic customer information corresponding to a select customer from a repository shared by multiple users;
organizing said strategic customer information into a plurality of information zones wherein each zone includes a related subset of said strategic customer information;
presenting said plurality of information zones on a display screen;
receiving requests from a user to update said strategic customer information; and
storing the updated strategic customer information in said repository.

33. The storage medium of claim 32 the method further comprising:
verifying a login request from a user to permit authenticated user to access the repository; and
selecting said select customer in accord with input from the authenticated user prior to retrieving said strategic customer information corresponding to said select customer.

34. The storage medium of claim 33
wherein the method step of selecting comprises:
selecting multiple select customers, and
wherein the method step of retrieving comprises:
retrieving said strategic customer information corresponding to all of said multiple select customers.

35. The storage medium of claim 32 the method further comprising: verifying a login request from a user to permit authenticated user to access the repository;
determining a user type associated with said authenticated user; and selecting said select customer as the authenticated user in response to a determination that the authenticated user is associated with a customer user type prior to retrieving said strategic customer information corresponding to said select customer.

36. The storage medium of claim 32 the method further comprising:
selecting, in response to input from a user, a current zone for display from said plurality of information zones,
wherein the method step of presenting comprises:
displaying said current zone on said display screen.

37. The storage medium of claim 36 the method further comprising:
selecting, in response to input from a user, selected fields of said strategic customer information in said current zone,
wherein the method step of displaying said current zone comprises:
displaying said selected fields of said current zone on said display screen.

38. A system for managing strategic customer information relating to one or more strategic customers of a business enterprise, the system comprising:
means for storing said strategic customer information in a central repository of said business enterprise; and
means for presenting said strategic customer information on a user's display wherein the information display is subdivided into a plurality of zones such that each zone includes a subset of related portions of said strategic customer information, and wherein the information display is customizable by the user to select desired portions of said strategic customer data.

39. The system of claim 38 further comprising:
means for selecting one zone of said plurality of zones in response to user input; and
means for displaying only portions of said strategic customer data stored in the selected said one zone.

40. The system of claim 39 further comprising:
means for customizing the display of said one zone on the user's display in response to receipt of user input.

41. The system of claim 40 wherein the means for customizing comprises: means for selecting a portion of information stored in said one zone in response to receipt of said user input.

42. In a business enterprise, a system for collaborative customer planning comprising:
means for retrieving strategic customer information corresponding to a select customer from a repository shared by multiple users; means for organizing said strategic customer information into a plurality of information zones wherein each zone includes a related subset of said strategic customer information;
means for presenting said plurality of information zones on a display screen; means for receiving requests from a user to update said strategic customer information; and
means for storing the updated strategic customer information in said repository.

43. The system of claim 42 further comprising:
means for verifying a login request from a user to permit authenticated user to access the repository; and
means for selecting said select customer in accord with input from the authenticated user prior to retrieving said strategic customer information corresponding to said select customer.

44. The system of claim 43
wherein the means for selecting comprises:
means for selecting multiple select customers, and
wherein the means for retrieving comprises:
means for retrieving said strategic customer information corresponding to all of said multiple select customers.

45. The system of claim 42 further comprising:
means for verifying a login request from a user to permit authenticated user to access the repository;
means for determining a user type associated with said authenticated user; and
means for selecting said select customer as the authenticated user in response to a determination that the authenticated user is associated with a customer user type prior to retrieving said strategic customer information corresponding to said select customer.

46. The system of claim 42 further comprising:
means for selecting, in response to input from a user, a current zone for display from said plurality of information zones,
wherein the means for presenting comprises:
means for displaying said current zone on said display screen.

47. The system of claim 46 further comprising:
means for selecting, in response to input from a user, selected fields of said strategic customer information in said current zone,
wherein the means for displaying said current zone comprises:
means for displaying said selected fields of said current zone on said display screen.
